(19) United States
(12) Patent Application Publication
(10) Pub. No.: US 2003/0212825 A1
(43) Pub. Date: Nov. 13, 2003

(54) Method for sending a web page to a facsimile machine

(76) Inventors: Cheng-Sjing Lai, Taipei Hsien (TW); Ren-Ping Cao, Nanjing (CN); Jing Cao, Nanjing (CN)

Correspondence Address: NAIPO (NORTH AMERICA INTERNATIONAL PATENT OFFICE), P.O. BOX 506, MERRIFIELD, VA, 22116, US

(21) Appl. No.: 10/063,778

(22) Filed: May 12, 2002

(51) Int. Cl. G06F 15/16

(52) U.S. Cl. 709/246; 709/218

(57) ABSTRACT

A method for sending a web page to a fax machine includes a first computer capable of accessing a web page, a fax machine identified by a fax number and capable of receiving fax signals, and a transmission means connecting the fax machine to the first computer. The computer converts the web page into a fax signal and transmits the fax signal to the fax machine using the transmission means. The fax machine prints the fax signal representing the web page. Another computer can also send a fax signal through a computer network to the computer that is connected to a fax machine, and in this way print a web page at the fax machine.

### BACKGROUND OF INVENTION

1. Field of the Invention

The present invention relates to a method for sending a web page to a facsimile (fax) machine and more specifically to a method for sending a web page from a computer to a fax machine to be printed.

2. Description of the Prior Art

A web page is a popular way of storing information in a text or image format on a computer network. Computer users can browse web pages stored on a computer network, such as the Internet, to access this information. If desired, a user can use a printer to make a printout of a web page for later reference.

Fax machines are typically used to transmit facsimiles of hardcopy paper documents to other fax machines. A fax machine first connects to another fax machine using a fax number, and then transmits information using a fax signal. The quality of the faxed copy depends on the type of fax machines used, noise in the fax signal, and most importantly on the quality of the original document.

If a user wants to send information contained in a web page to a fax machine so that another person can view the information, the user faces several problems. First, the user requires a printer to make a printout of the web page. Second, the user needs to have convenient access to a fax machine in order to send the printout to another fax machine. Finally, the user must dial the fax number of the destination fax machine and manually feed the printout into the fax machine. This method of sending web page information to a fax machine is time consuming and inconvenient. Moreover, printing a document and then faxing it leads to degraded text and image quality in the faxed copy compared to the original web page.

The prior art method of sending a web page to a fax machine is inconvenient and results in a low quality faxed document.

### SUMMARY OF INVENTION

It is therefore a primary objective of the claimed invention to provide a method for sending a web page to a remote fax machine to be printed to solve the problems of the prior art.

Briefly summarized, the claimed invention comprises providing a first computer capable of accessing a web page, a fax machine identified by a fax number capable of receiving fax signals, and a transmission means connecting the fax machine to the first computer. The method comprises converting the web page into a fax signal using the first computer, and transmitting the fax signal from the first computer to the fax machine through the transmission means.

According to the claimed invention a second computer can be connected to the first computer through a computer network, which can be the Internet, such that the second computer converts the web page to the fax signal and sends the fax signal to the fax machine through the first computer. Both the first and second computers can have a user interface to allow a user to control the converting of the web page and the sending of the fax signal.

It is an advantage of the claimed invention that a user can send a web page to a fax machine using a computer, without requiring a printer and a second fax machine, in a convenient way resulting in a high quality faxed image.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a method of sending a web page to a fax machine according to a first embodiment of the present invention.

FIG. 2 is a flowchart of a computer program used by the first computer in FIG. 1.

FIG. 3 is a schematic diagram of a method of sending a web page to a fax machine according to a second embodiment of the present invention.

FIG. 4 is a flowchart of a computer program used by the second computer in FIG. 3

### DETAILED DESCRIPTION

Two embodiments of the present invention will be described. The first embodiment is relevant to a case where a computer has a fax modem and can directly connect to a fax machine through a telephone line. The second embodiment pertains to a situation where a computer does not have a fax modem and instead connects to another computer that has access to a fax machine through a computer network. Both embodiments have advantages and overcome the problems of the prior art.

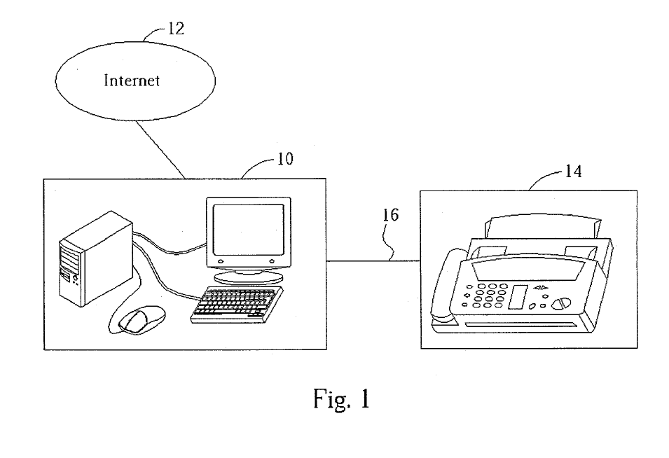

Please refer to FIG. 1, which shows a schematic diagram of a method of sending a web page to a fax machine according to a first embodiment of the present invention. A first computer 10 is connected to the Internet 12 through a typical Internet connection, such as an ADSL connection, and can receive a web page from the Internet 12. The web page can be a combination of text and images, and is usually comprised of hypertext markup language (HTML) code. While web page can originate from the Internet 12, it can also be stored locally on the computer 10.

The computer 10 is also connected to a fax machine 14, typically an ITU-T Group 3 Facsimile machine, through a transmission means 16. The transmission means is commonly a fax modem and a telephone line, but can also be a radio or satellite transmission system. The computer 10 can connect to the fax machine 14 using a unique fax number of the fax machine 14. Once connected, the computer 10 can send a fax signal to the fax machine 14 through the transmission means 16. The fax signal is a standardized compressed signal that can be stored digitally, as a bitmap image for example, on the computer 10.

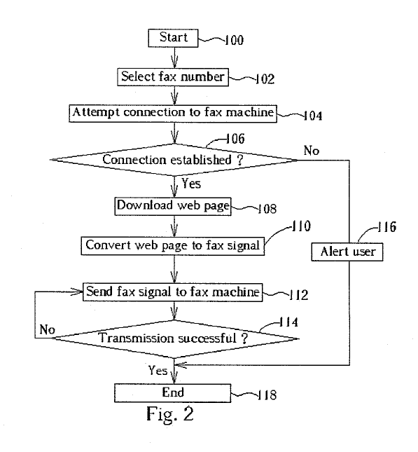

A user wishing to print the web page at the fax machine 14 simply executes a program on the computer 10. A flowchart of the program is shown in FIG. 2 and is detailed as follows:

Step 100: Start;

Step 102: The fax number is selected corresponding to the destination fax machine 14;

Step 104: A connection is attempted by the computer 10 to the fax machine 14;

Step 106:

Is the connection to the fax machine 14 established correctly? If the connection is established correctly then go to step 108, if it is not then go to step 116;

Step 108:

The computer 10 downloads the web page from the Internet 12. Alternately, a locally stored web page could be specified;

Step 110:

The computer 10 converts the web page into the fax signal. At this time, the computer 10 can store in its file system a temporary file containing a copy of the fax signal;

Step 112:

The computer 10 sends the fax signal to the fax machine 14 through the transmission means 16;

Step 114:

The computer 10 and fax machine 14 determine if the transmission of the fax signal was successful. If transmission was successful go to step 118, if transmission was unsuccessful go to step 112;

Step 116:

The computer 10 alerts a user or related program that a connection cannot be established to the fax machine 14;

Step 118: End.

In the conversion process described in Step 110, the program first converts text and image information of the web page into a bitmap image. The program then compresses and further manipulates the bitmap image into the fax signal, which is typically a Modified Huffman coded signal. Note that the fax signal can also be represented as another bitmap image in the storage system of the computer 10.

The described program has a user interface to allow the user to control the program to convert the web page into the fax signal, and to send the fax signal to the fax machine 14. The program can also function in an automatic mode, where relevant parameters for execution are specified ahead of time by the user or by another program. In the automatic mode, the fax number is provided by a source other than direct user input and user prompts are suppressed, resulting in user interaction being minimized.

The fax machine 14, upon receiving the fax signal, behaves in a normal manner. The fax machine 14 will usually immediately print the fax signal, but could also store the fax signal in a buffer to be printed later.

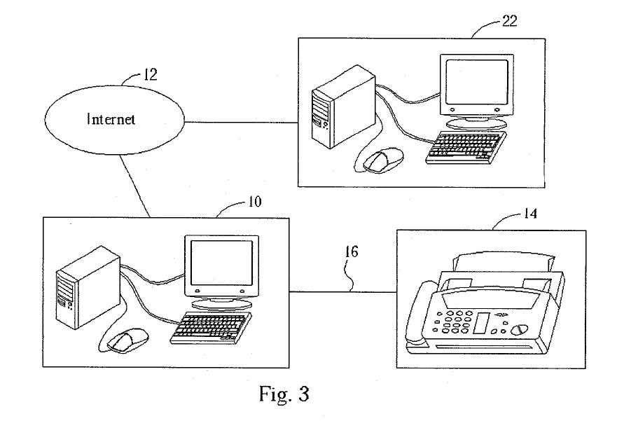

Please refer to FIG. 3, which shows a schematic diagram of a method of sending a web page to a fax machine according to a second embodiment of the present invention. As in the first embodiment, the first computer 10 is connected to the Internet 12, and to the fax machine 14 via the transmission means 16. In this embodiment, however, a second computer 22 is provided also connected to the Internet 12. The second computer 22 is capable of receiving another web page from the Internet, or alternately from a local storage device, and is capable of converting the web page into another fax signal.

In this second embodiment the second computer 22 executes a program to convert the web page to the fax signal and to transmit the fax signal to the first computer 10 via the Internet 12. The first computer 10 receives the fax signal and sends the fax signal to the fax machine 14. In effect, the second computer 22 is remotely accessing the transmission means 16 of the first computer 10 to send the fax signal to the fax machine 14. In practical application the first computer 10 has an interface application installed that allows the second computer 22 to have direct access to the fax modem of the first computer 10, and that returns related feedback information to the second computer 22. A network protocol for communication between the second computer 22 and the first computer 10 is decided upon ahead of time, but the net effect of this is that the fax signal can be sent from the second computer 22, through the Internet 12, and to the first computer 10.

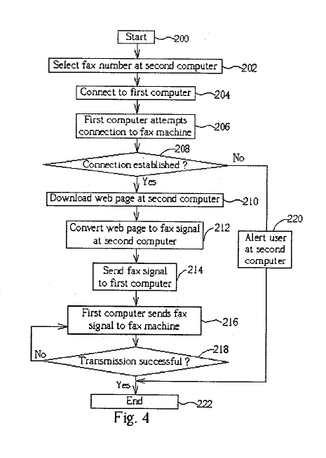

A user wanting to print the web page at the fax machine 14 simply executes a program on the second computer 22. A flowchart of the program is shown in FIG. 4 and is detailed as follows:

Step 200: Start;

Step 202:

A fax number is selected at second computer 22 corresponding to the destination fax machine 14;

Step 204:

The second computer 22 connects to the first computer 10 through the Internet 12;

Step 206:

The second computer 22 sends the fax number to the first computer 10, and commands the first computer 10 to attempt to connect to the fax machine 14;

Step 208:

The first computer 10 determines if the connection to the fax machine 14 is established correctly. If the connection is established correctly then go to step 210, if not then go to step 220;

Step 210:

The second computer 22 downloads the web page from the Internet 12. Alternately, the web page could be retrieved from a local storage system;

Step 212:

The second computer 22 converts the web page into the fax signal. At this time, the second computer 22 can store in its file system a temporary file containing a copy of the fax signal;

Step 214:

The second computer 22 sends the fax signal to the first computer 10 via the Internet 12. The first computer 10 returns an indication of receipt of the fax signal to the second computer 22;

Step 216:

The first computer 10 sends the fax signal to the fax machine 14;

Step 218:

The first computer 10 and fax machine 14 determine if the transmission of the fax signal was successful, and the first computer 10 informs the second computer 22 of this. If transmission was successful go. to step 222, if transmission was unsuccessful go to step 216;

Step 220:

The first computer 10 informs the second computer 22 that a connection cannot be established to the fax machine 14. The second computer 22 alerts the user or a related program;

Step 222: End.

Similar to the first embodiment, in the conversion process described in Step 212, the program first converts text and image information of the web page into a bitmap image. The program then compresses and further manipulates the bitmap image into the fax signal, which is typically a Modified Huffman coded signal. Again note that the fax signal can also be represented as another bitmap image in the storage systems of the second computer 22 and the first computer 10. Additionally, the first computer 10, controlled by the second computer 22, could perform the conversion process described in Step 212. In this case the second computer 22 would send the web page, rather than the fax signal, to the first computer 10.

The program described above has a user interface to allow the user to control the program to convert the web page into the fax signal at the second computer 22, and to send the fax signal to the first computer 10, which then sends the fax signal to the fax machine 14. Similar to the first embodiment, the program can also function in an automatic mode, where relevant parameters for execution are specified in advance by the user or by another program. In the automatic mode, the fax number is provided by a source other than direct user input and user prompts are suppressed, resulting in user interaction being minimized.

As in the first embodiment, the fax machine 14, upon receiving the fax signal, behaves normally. The fax machine 14 will usually immediately print the fax signal, but could also store the fax signal in a buffer to be printed later.

In contrast to the prior art, the present invention can send a web page to a fax machine using a computer. The present invention offers convenience and results in a high quality faxed image. Furthermore, the computer can send a web page to a fax machine utilizing the Internet and without directly requiring a fax modem or other fax transmission means.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for sending a web page to a remote facsimile (fax) machine to be printed comprising:
providing a first computer capable of accessing a web page;
providing a fax machine identified by a fax number capable of receiving fax signals;
providing a transmission means connecting the fax machine to the first computer;
converting the web page into a fax signal;
transmitting the fax signal from the first computer to the fax machine identified by the fax number through the transmission means; and
receiving the fax signal at the fax machine.

2. The method of claim 1 further comprising using the fax machine to print the fax signal immediately upon receiving the fax signal.

3. The method of claim 1 further comprising storing the fax signal in a buffer of the fax machine.

4. The method of claim 1 wherein the web page is converted into the fax signal by using the first computer.

5. The method of claim 1 wherein the first computer has a user interface, the method further comprising using the user interface to control conversion of the web page into the fax signal and sending of the fax signal to the fax machine.

6. The method of claim 1 further comprising transmitting the fax signal to the fax machine again if a previous transmission of the fax signal to the fax machine fails.

7. The method of claim 1 wherein the fax signal is a bitmap image.

8. The method of claim 1 further comprising storing the fax signal in a temporary file in the first computer.

9. The method of claim 1 wherein the web page is downloaded to the first computer from Internet.

10. The method of claim 1 further comprising:
providing a second computer connected to the first computer through a computer network; and
using the second computer to convert another web page into another fax signal and sending the fax signal to the fax machine through the first computer.

11. The method of claim 10 wherein the computer network is Internet.

12. The method of claim 10 wherein the second computer has a user interface, the method further comprising using the user interface to control conversion of the web page into the fax signal and sending of the fax signal to the fax machine.
